(19) United States
(12) Patent Application Publication
(10) Pub. No.: US 2004/0068875 A1
(43) Pub. Date: Apr. 15, 2004

(54) Handheld planer with a chips exhausting direction changeable chip-ejecting duct

(76) Inventor: Xin Wang, Xinxiang Garden (CN)

Correspondence Address: James V. Costigan, Esq., Hedman & Costigan, P.C., Suite 2003, 1185 Avenue of the Americas, New York, NY, 10036-2646, US

(21) Appl. No.: 10/402,921

(22) Filed: Mar. 28, 2003

(30) Foreign Application Priority Data
Mar. 29, 2002 (CN) 02229840.1

(51) Int. Cl. B27C 1/00; B26B 19/14

(52) U.S. Cl. 30/207; 144/114.1

(57) ABSTRACT

The present invention relates to a handheld planer with a chip-ejecting duct, more particularly, the chip ejecting direction of the chip-ejecting duct is changeable. The planer comprising: a driving motor, a transmission strap, a tool blade, a blade shank, a button for adjusting cutting depth, an adjustable base, a motor output shaft, a fan, an air department, a outlet for airflow out, the outlets for chips and a chip-ejecting duct. There is a plate in the chip-ejecting duct, and the plate divide the chip-ejecting duct into left and right departments. There are inlets for airflow into and inlets for the chips into on the wall of the duct, and the wall respectively face the said plate downwardly and upwardly. The inlets for airflow into and inlets for chips into respectively communicate with the said outlet for airflow and outlet for chips out on the planer, thereby formed the chip ejecting passages and outlets for exhausting chips in opposite directions. The present invention extend the using range by using the direction changeable chip-ejecting duct. The planer with a chip-ejecting duct can be used in various circumstances, and can be operated by the operators having different operating customs. Besides, comparing with the conventional design, the other obvious advantage of present invention is the air produced by the rotation of the said fan can blows to everywhere of the chip-ejecting duct result in the position of the said plate is disposed near to the converge portion of the said plate and the said chip-ejecting duct, wherein the other side of the said chip-ejecting duct was blocked such that the chips ejecting effect is very good, and at the same time the practicality of this design is perfect.

### TECHNICAL FIELD

The present invention relates to a handheld planer, more particularly, the handheld planer with a chip-ejecting duct which chip exhausting direction is changeable. A handheld planer having a housing supporting a planer head rotatable by a driving motor, a fan connected with the motor for generating a airflow for moving chips, a chip ejecting duct to which the airflow is guided via the passages of the duct, and the chips producing during the work is carry out form the outlets of the chip-ejecting duct finally.

### BACKGROUND INFORMATION

The handheld planers are widely used in the woodwork. And the chips producing during the planer working exhausting system and the satisfying effect of the chip exhausting system has been a problem under resolved perfectly for a long time. One planer of the convention design (U.S. Pat. No. 5,815,934) disclose a technical proposal, there is a valve disposed in the chip exhausting duct, and there are two passage and two outlets on the chip exhausting duct. The said two passages don't open simultaneously. The air passes through the whole length and takes the chips away. The effect of this kind design is good and use expediently, but the structure of this design is very complicate and they're a small work portion of the chip-exhausting duct. The other handheld planer(U.S. Pat. No. 5,383,275) also mentions a design to resolve the problem of chips exhausting. There is a duct with an inserting plate. There is a bevel on the duct, and having openings on the bevel, the air flow come form the air passage pass through the openings on the bevel and change the direction of air then enter into the duct, the air take the chips away during this progress. This structure also can achieve a effect of changeable chip exhausting direction, but is not so convenient during operating, and the chip exhausting effect of the left side of the structure is extremely different with the chip exhausting effect of the right side of the structure.

### Invention Content

The present invention aims at providing a planer with an improved chip exhausting direction changeable duct. The duct can obtain the purpose of convenient changing the direction of the chip exhausting. The advantages are the structure of the present design is very simple, and have a largest ventilating area. A perfect chip exhausting effect can be obtained.

A handheld planer with a chip-ejecting duct, more particularly, the chips ejecting direction of the chip-ejecting duct is changeable. The said handheld planer comprising: a driving motor, a transmission strap, a tool blade, a blade shank, a button for adjusting cutting depth, an adjustable base, a motor output shaft, a fan, an air department, a outlet for airflow out, a outlet for chips out and a chip-ejecting duct is disposed upon the outlet for airflow out and the outlet for chips out. The characterized in that there is a plate in the chip-ejecting duct and the plate divide the chip-ejecting duct into left and right departments. There are inlets for airflow into and inlets for the chips into on the wall of the chip-ejecting duct, and the wall respectively face the said plate downwardly and upwardly. The chip-ejecting duct operable connected to the outlet for airflow out of the planer, and the duct can rotate about the axis of itself, further after rotating a certain angle the duct still can connected with the outlet for airflow out of the planer.

In the foregoing mentioned planer with a chip-ejecting duct which chip exhausting direction changeable, thereinto, the said plate is a tilt disposed in the duct and is planar thin plate, the two ends of the plate bend to the wall of duct and connect wherein with good sealing manner, the said plate divide the chip-ejecting duct into two departments, further formed two chip exhausting passages and two outlets for chip ejecting.

In the foregoing mentioned planer with a chip ejection duct which chip exhausting direction changeable, thereinto, the connecting positions of the upper end and lower end of the plate are arranged at the two side of the outlet for airflow out and the outlet for chips ejecting. The plate is just position above the outlet for airflow out and the outlet for chips exhausting when the inlets for airflow into and inlets for chips into of the chips exhausting duct communicate with the outlet for airflow out and the outlet for chips exhausting.

In the foregoing mentioned planer with a chip ejection duct which chip exhausting direction changeable, thereinto, the horizontal width of the said inlets for airflow into is not larger than the horizontal width of the outlet for airflow out, and the length of the said inlets for airflow into is not smaller than the length of the outlet for air flow out.

In the foregoing mentioned planer with a chip ejection duct which chip exhausting direction changeable, thereinto, the said inlets for airflow into symmetry stagger disposed on the each side of the plate in the vertical direction, the located position of the said inlets for airflow into is at the converge point of the said plate and the chip-ejecting duct. One of the said inlets is just communicate with one portion of the said outlet for airflow out of the planer when the said plate is above of the said outlet for airflow out and outlet for chips exhausting. The other one of the said inlets is just communicate with the other portion of the outlet for airflow out after the chip-ejecting duct rotate a certain angle about the axis of itself.

In the foregoing mentioned planer with a chip ejection duct which chip exhausting direction changeable, thereinto, the length and the width of the inlets for chips into is not smaller than the length and the width of the said outlet for the chip exhausting.

In the foregoing mentioned planer with a chip ejection duct which chip exhausting direction changeable, thereinto, the said inlets for chips into symmetry disposed on the two sides of the said plate in the vertical direction. One of the said inlets for chips into is just communicate with the outlet for chips out when the said plate is above of the outlet for airflow out of the said handheld planer and the outlet for chips exhausting. The other one of the said inlets for chips into is just communicate with the said outlet for chips out after the said duct rotating a certain angle about the axis of itself.

In the foregoing mentioned planer with a chip ejection duct which chip exhausting direction changeable, thereinto, there is a ring member for moving along the said chip-ejecting duct and limiting the position of the said chip-ejecting duct on the planer. And further, the ring member also is for operable connect the said duct to the planer after the duct rotating a certain angle about the axis of itself.

Comparing with the prior arts, the planer with a said chip-ejecting duct having the following advantages result in the foregoing design:

1. In the present invention, the chip-ejecting duct is divided into left and right departments so that formed two airflow passages and two outlets for ejecting chips result in using a plate in the duct. The inlets for airflow into and the inlets for chips into are arranged respectively on the two sides of the plate in the vertical direction, and the said chip-ejecting duct can rotate a certain angle about the axis of itself such that the chips ejecting direction of the planer can be change conveniently. Furthermore, also by the structure foregoing, the present invention suitable for the operators who have different operating customs. Even only operate by one operator, the design also can be used in different ways and release the tiredness of the operator. And the planer with the foregoing improved design also can be used in various circumferences.

2. In the present invention, by disposing the size of the said inlets for airflow into are smaller than the size of the said outlet for airflow out, and by positioning the said plate at the converge point of the said plate and the chip-ejecting duct. The other side not in work of outlet for air flow out is blocked when one side of the said chip-ejecting duct. Such that the airflow come form the rotation of the fan can blow around everywhere of the working portion of the said chip-ejecting duct, and so obtain an perfect chip exhausting effect.

### BRIEF DESCRIPTION OF THE DRAWINGS

FIG. 1 shows a partially broken side view of the planer responsible to the present invention.

FIG. 2 shows a sectional view along the line L-L of FIG. 1.

FIG. 3 shows the structure of the chip-ejecting duct responsible to the present invention. I.e. shows the cross-sectional view along the line P-P of FIG. 1.

FIG. 4 shows the sectional view along the line Q-Q of FIG. 3.

FIGS. 5A-5C show section, side and front views of a ring element.

FIG. 6 shows a side view of a chip-ejecting duct of FIGS. 3 and 4.

### DESCRIPTION OF THE PREFERED EMBODIMENTS

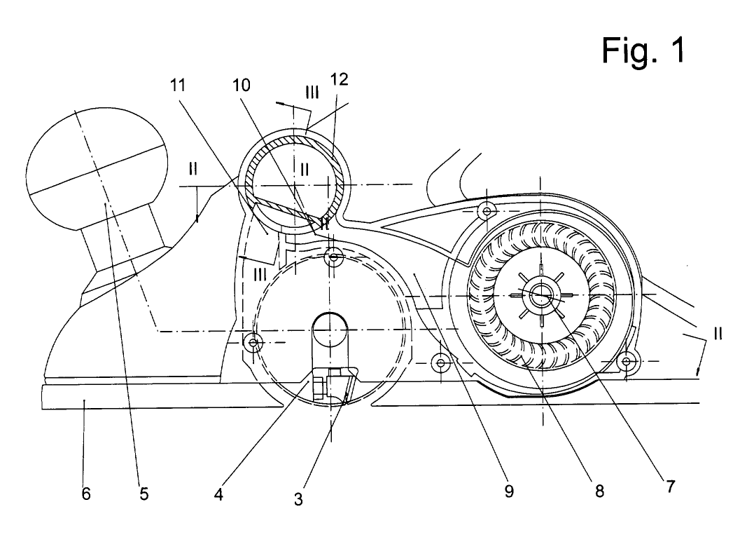

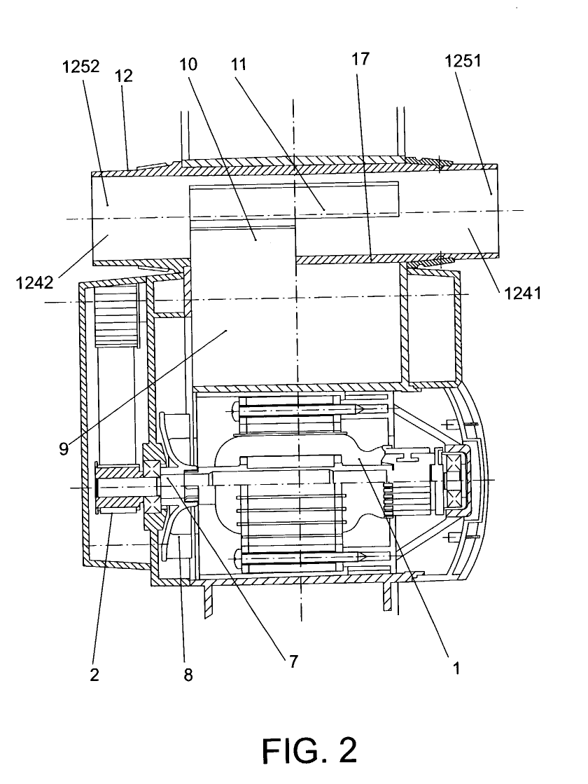

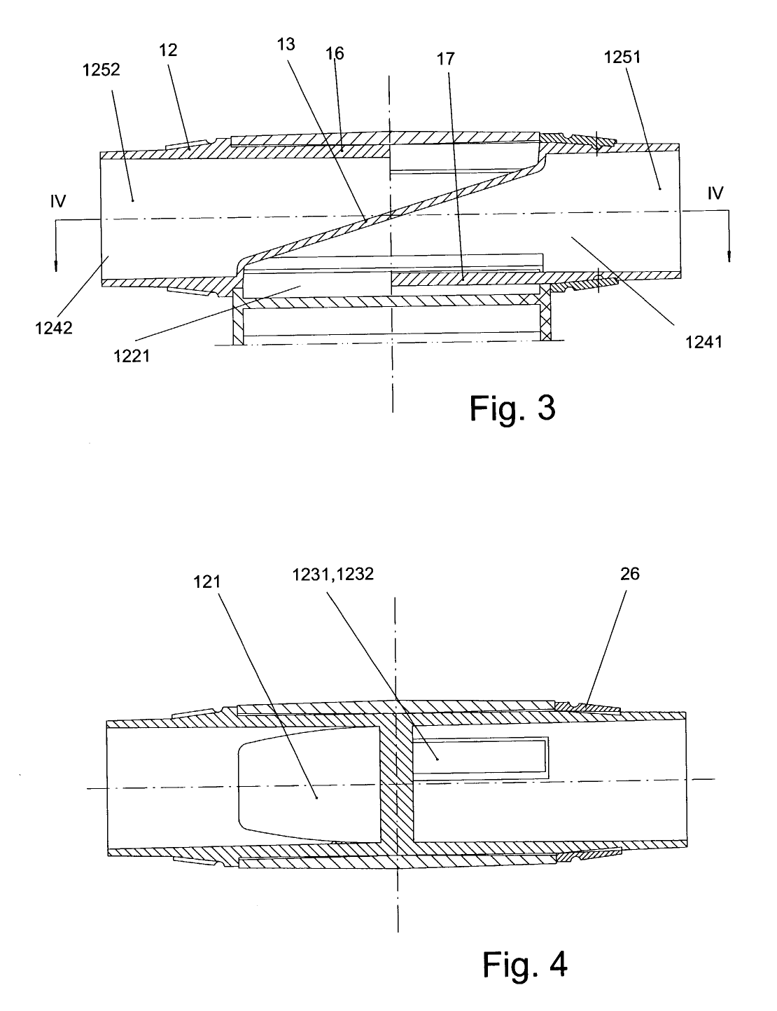

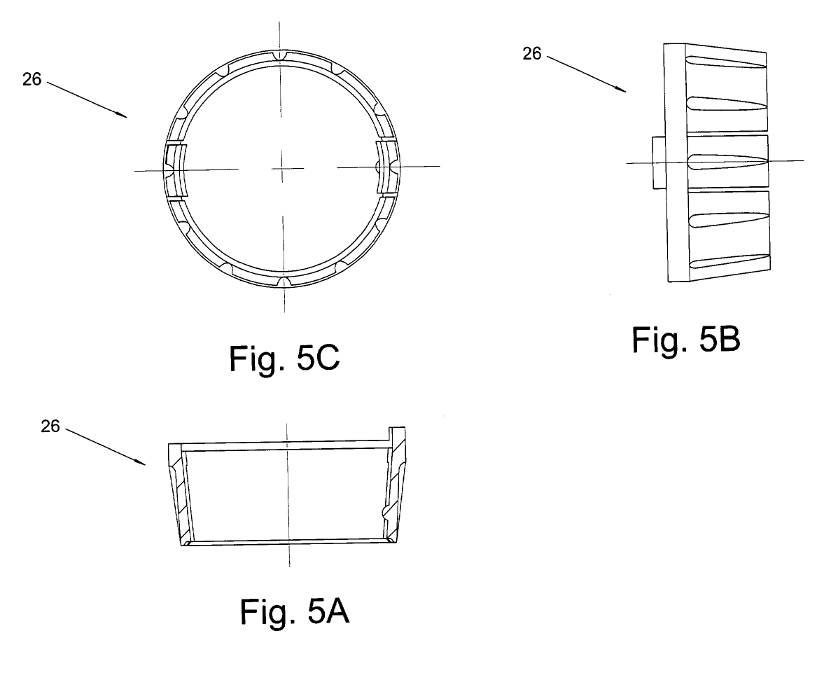

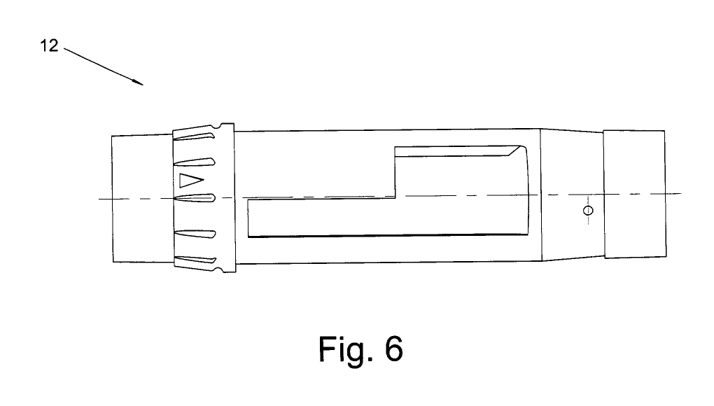

The handheld planer show in the FIG. 1 and FIG. 2, comprising: a driving motor (1), a transmission strap (2), a tool blade (3), a blade shank (4), a button (5) for adjusting cutting depth, an adjustable base (6), a motor output shaft (7), a fan (8), an air department (9), a outlet (10) for airflow out, a outlet (11) for chips out and a chip-ejecting duct (12). There is a plate (121) in the chip-ejecting duct (12), and the plate divide the chip duct into left and right departments. There are inlets (1221, 1222) (see the FIG. 3) for airflow into and inlets (1231, 1232) (see the FIGS. 3 and 4) for the chips into on the wall of the chip-ejecting duct (12). The chip-ejecting duct (12) operable connect to the planer, and can rotate about the axis of itself.

The handheld planer show in FIG. 3 and FIG. 4, there is a plate (121) in the chip-ejecting duct (12), the plate is a thin planar plate member and tilt arranged in the chip-ejecting duct (12). The upper and lower ends of the plate bend toward and sealing connected to the wall of the chips ejecting duct (12), such that the chip-ejecting duct (12) is divided into left and right departments, and formed two airflow passages (1241, 1242) and two outlets (1251, 1252) for chips ejecting. The connecting position of the upper and lower ends of plate (121) are responsible to the positions of the said outlet (10) for airflow out and the said outlet (11) for chips ejecting. The said plate is above of the said outlet (10) for airflow out and outlet (11) for the chips ejecting when the said inlets (1221, 1222) for airflow entering and the inlets (1231, 1232) for chips entering of the chip-ejecting duct (12) communicate with the said outlet (10) for airflow out and the said outlet (11) for chips out.

The horizontal width of the said inlets (1221, 1222) for airflow into is not larger than the horizontal width of the outlet (10) for airflow out form the inner housing of the planer. And the length of the said inlets (1221, 1222) for airflow into is smaller than the length of the outlet (10) for airflow out form the housing of the planer. The inlets (1221, 1222) for air flow symmetry stagger disposed on the each side of the plate (121) in the vertical direction, the located position of the said inlets (1221, 1222) for airflow into is nearest to the converge point of the said plate (121) and the chip-ejecting duct (12). One of the said inlets (1221, 1222) for airflow into is just communicate with one portion of the said outlet (10) for air flow out when the said plate (121) is above of the said outlet (10) for airflow out and outlet (11) for chips exhausting. The other one of the said inlets (1221, 1222) for airflow into is just communicate with the other portion of the outlet (10) for airflow out after the chip-ejecting duct (12) rotate a certain angle about the axis of itself.

The length and the horizontal width of the inlets (1231, 1232) for chips into is not smaller than the length and the horizontal width of the outlet (11) for chips out. The said inlets (1231, 1232) for chips into symmetry disposed on the two sides of the said plate (121) in the vertical direction. One of the said inlets (1231, 1232) for chips into is communicate with the outlet (11) for chips out when the said plate (121) is above of the outlet (10) for airflow out and the outlet (11) for chips exhausting. A ring member (26) mount on the chip-ejecting duct (12) for moving along the duct and limited the position of the duct such that the said duct can operable connect with the planer, and furthermore, the said duct can connect with the planer again after rotating an angle about the axis of itself, and the other of the inlets (1231, 1232) for chips into communicate with the outlet (11) for chip simultaneously.

During working, the inlet (1221) communicate with the outlet (10) for airflow out when the plate (121) in the chip-ejecting duct (12) is in the position left end lower than the right end, wherein the inlet (1231) for chips into communicate with outlet (11) for chips out and the wood chips is carry out from the right portion (1241) of the chip-ejecting duct (12). The inlet (1222) for airflow into communicate with the outlet (10) for airflow out, and the inlet (1231) for chips into simultaneously communicate with the outlet (11), and the wood chips is carry out from the left portion (1242) of the chips ejecting duct (12) by the airflow when the plate (121) in the chip-ejecting duct (12) is in the position left end higher than the right end after the chip-ejecting duct (12) rotate a certain angle about the axis of itself.

By used the foregoing technical proposal, a handheld planer with an improved chip-ejecting duct suitable for the operators who have different operating customs. Even only operate by one operator, the design also can be used in different ways and release the tiredness of the operator. And the planer with the foregoing improved design also can be used in various circumferences. And furthermore, by disposing the size of the said inlets for airflow into are smaller than the size of the said outlet for airflow out, and by positioning the said plate at the converge point of the chip-ejecting duct and the said plate. The other side of outlet for airflow out is blocked when one side of the outlet for airflow out is working. Such that the airflow come form the rotation of the fan driving by the motor can blow around everywhere of the working portion of the said chip-ejecting duct, and obtain an perfect chip exhausting effect and extensively practicability at the same time.

1. A handheld planer with a chip-ejecting duct, comprising a driving motor(1), a transmission strap(2), a tool blade(3), a blade shank(4), a button(5) for adjusting cutting depth, a adjustable base(6), a motor output shaft(7), a fan(8), a air department(9), a outlet for air(10), a outlet for chips(11), and a chip-ejecting duct (12) which disposed on the outlet for airflow out and the outlet for chips out, characterized in that:
a plate(121) is disposed in the chip-ejecting duct (12);
the inlets(1221, 1222) for the airflow into and the inlets(1231, 1232) for the chips into are disposed in the wall of the chip-ejecting duct (12) that confront with the plate from the upward side and downward side; the said chip-ejecting duct (12) operable connected to the said outlet (10) for airflow out of the said handheld planer, and rotatable about the axis of itself, and after rotate a certain angle, the said chip-ejecting duct (12) also can be connected with the said outlet (10) for airflow out.

2. The handheld planer of claim 1, wherein the said plate(121) is a thin planar plate (121) tilting disposed in the said chip-ejecting duct (12), the upper end and lower ends bend toward and upto the wall of the said chip-ejecting duct and sealed connected whereto; the said plate divided the said chip-ejecting duct into two departments, and formed two chips exhausting passages(1241, 1242) and two outlets(1251, 1252).

3. The handheld planer of claim 1 or 2, wherein the connecting position of the upper and lower ends of the said plate (121) responsible to the positions of the said outlet for airflow out (10) and outlet for chips out (11), the said outlet for airflow out communicate with outlet for chips out when the inlets for airflow into communicate with the said inlets for chips into, and the said plate (121) just position above the said outlet for chips out.

4. The planer of claim 1, wherein the horizontal width of inlets for airflow not larger than the horizontal width of outlet for airflow out, the length of the said inlets for airflow into is shorter than the length of the said outlet for airflow out.

5. The handheld planer of claim 1 or 4, wherein the said inlets for airflow into (1221,1222) are stagger and symmetry disposed on the each side of the said plate (121) in the vertical direction, and the position of inlets for airflow into is nearest to the converge portion of the plate and the said chip-ejecting duct. One of the said inlets (1221, 1222) for airflow into is just communicate with one part of the outlet for airflow into when the said plate (121) is above of the said outlet (10) for airflow out and the said outlet (11) for chips out, and the said inlets (1221, 1222) for airflow into is just communicate with the other portion of the outlet (10) for airflow out after the chip-ejecting duct rotate a certain angle about the axis of itself.

6. The handheld planer of claim 1, wherein the length and the horizontal width of the said inlets (1231, 1232) for chips into are not smaller than the length and the horizontal width of the said outlet (11) for chips out.

7. The handheld planer of claim 1 or 5, wherein the said inlets (1231, 1232) for chips are symmetry disposed on the each side of the said plate in the vertical direction. One of he said inlets for chips (1231,1232) communicate with the outlet (11) for chips out when the said plate is above of the said outlet (11) for air out and the outlet (10) for airflow out, and the other one of the said inlets (1231, 1232) may communicate with the outlet (11) for chips out after the chip-ejecting duct (12) rotate a certain angle about the axis of itself.

8. The handheld planer of claim 1, wherein there is a ring member on the said chip-ejecting duct (12).
